(19) United States
(12) Patent Application Publication
(10) Pub. No.: US 2026/0356607 A1
(43) Pub. Date: Nov. 12, 2026

(54) MOVABLE TUBE CONVEYOR

(71) Applicant: UNOZAWA ENGINEERING SERVICE CO., LTD., Tokyo (JP)

(72) Inventors: Shuichi TODATE, Tokyo (JP); Hiroshi FUJITA, Tokyo (JP)

(21) Appl. No.: 19/715,007

(22) Filed: Jun. 22, 2026

Related U.S. Application Data
(63) Continuation of application No. PCT/JP2025/036669, filed on Oct. 17, 2025.

(30) Foreign Application Priority Data
Dec. 10, 2024 (JP) 2024-215954

(51) Int. Cl. B65G 65/38; B65G 33/14

(52) U.S. Cl. CPC B65G 65/38; B65G 33/14; B65G 2203/0283; B65G 2203/047

(57) ABSTRACT

A movable tube conveyor includes a feeder tube, a traveling unit, pairs of arrival detection parts, and a control unit. The arrival detection parts detect arrival of each of the first and second traveling part, and include first and second detection parts arranged along a traveling direction of the traveling unit so as to correspond to each other in position at intervals not exceeding a limit value of a difference in traveling distance between the first and second traveling parts. When one of the first detection parts detects arrival of the first traveling part, the control unit controls traveling of the traveling unit such that a difference in the traveling distance does not exceed the limit value, by stopping the first traveling part until one of the second detection parts corresponding to the one of the first detection part detects arrival of the second traveling part.

### CROSS-REFERENCE TO RELATED APPLICATIONS

This application is a continuation application of International Application No. PCT/JP 2025/036669, filed on Oct. 17, 2025, which claims priority to Japanese Patent Application No. 2024-215954 filed in Japan on Dec. 10, 2024. The entire disclosures of International Application No. PCT/JP2025/036669 and Japanese Patent Application No. 2024-215954 are hereby incorporated herein by reference.

### BACKGROUND

### Technical Field

The present invention relates to a movable tube conveyor, and more particularly to a movable tube conveyor configured to discharge bulk material while a feeder tube travels beneath a silo.

### Background Information

Movable tube conveyors such as one disclosed in, for example, Japanese Patent Application Kohyo Publication No. 2016-514660 have been conventionally known. Such movable tube conveyors include a cylindrical tube having a plurality of inlet openings provided along a longitudinal direction thereof, a screw provided inside the tube coaxially with the tube, a rotary unit configured to relatively rotate the tube and the screw, and a traveling unit configured to cause a feeder tube to travel laterally. The traveling unit is disposed at both ends of the feeder tube, and the feeder tube travels beneath a silo laterally with respect to the silo.

The traveling units disposed at both ends of the feeder tube are configured to travel independently of each other. Therefore, when the feeder tube travels laterally with respect to the silo, the traveling units are synchronously operated such that the feeder tube travels straight without skewing. As a control unit for synchronous operation, a self-synchronizer (synchro) has been generally used. The self-synchronizer electrically couples two motors so that a rotational shaft of one motor rotates in accordance with rotation of a rotational shaft of the other motor. The self-synchronizer configured as described above is used to control rotational positions of the rotational shafts of the traveling units disposed at both ends, thereby eliminating a difference in traveling distance and preventing skewing.

### SUMMARY

The self-synchronizers, which are control units for traveling units used in conventional movable tube conveyors, are precision components and are therefore vulnerable to heat and vibration. Further, since the self-synchronizers perform synchronous operation based on electrical rotation control of rotational shafts, the control is not necessarily consistent with an actual traveling distance, and therefore there has been a concern about erroneous detection. Furthermore, the self-synchronizers are expensive and require electric circuits for traveling control. Therefore, there has been a demand for a movable tube conveyor that is resistant to damage, has a reduced risk of erroneous detection, and can be manufactured at low cost.

The present invention has been made in view of the above situation, and an object thereof is to provide a movable tube conveyor that is resistant to damage, has a reduced risk of erroneous detection, and can be manufactured at low cost.

To achieve the above object of the present invention, a movable tube conveyor according to the present invention comprises a feeder tube including a tube having a plurality of inlet openings for taking in the bulk material, a screw disposed inside the tube and sharing a common axis with the tube, and rotating mechanisms each configured to relatively rotate the tube and the screw about the common axis; a traveling unit configured to allow the feeder tube to travel across a lower opening of the silo and including a first traveling part and a second traveling part disposed at both ends of the tube; a plurality of pairs of arrival detection parts configured to detect arrival of the first traveling part and the second traveling part, respectively, of the traveling unit and including first detection parts and second detection parts arranged along a traveling direction of the traveling unit so as to correspond to each other in position at predetermined intervals not exceeding a limit value of a difference in traveling distance between the first traveling part and the second traveling part; and a control unit configured to control traveling of the traveling unit such that the difference in the traveling distance between the first traveling part and the second traveling part does not exceed the limit value, by stopping, when one of the first detection parts of the plurality of pairs of the arrival detection parts detects arrival of the first traveling part, traveling of the first traveling part until one of the second detection parts, which is disposed corresponding to the one of the first detection parts, detects arrival of the second traveling part.

The control unit controls the traveling of the traveling unit such that, when the one of the second detection parts detects the arrival of the second traveling part, traveling of the second traveling part is stopped, and thereafter the traveling of the second traveling part is resumed together with the first traveling part which has already been stopped.

The control unit controls the traveling of the traveling unit such that, when the one of the second detection parts detects the arrival of the second traveling part, traveling of the second traveling part is continued, and the traveling of the first traveling part, which has already been stopped, is resumed.

The first arrival detection parts and the second arrival detection parts of the plurality of pairs of arrival detection parts are each be formed by a limit switch, and the first traveling part and the second traveling part of the traveling unit each have a striker that comes into contact with the limit switch upon arrival thereat.

The movable tube conveyor further comprises a plurality of pairs of erroneous operation preventing parts including first erroneous operation detection parts and second erroneous operation detection parts each configured to detect arrival of the first traveling part and the second traveling part of the traveling unit. The plurality of the pairs of erroneous operation preventing parts are disposed at positions between the predetermined intervals where the plurality of pairs of arrival detection parts are arranged. The control unit determines that one of the plurality of pairs of arrival detection parts has erroneously operated and controls the traveling of the traveling unit to stop the traveling of the traveling unit when a next pair of the plurality of pairs of erroneous operation preventing parts, which is adjacent to the one of the plurality of pairs of arrival detection parts in the traveling direction, detects arrival of the traveling unit before the one of the plurality of pairs of arrival detection parts detects arrival of the traveling unit.

The plurality of pairs of erroneous operation preventing parts are be formed by using the plurality of pairs of arrival detection parts.

The first detection parts and the second detection parts of the plurality of pairs of arrival detection parts are each be formed by a striker, and the first traveling part and the second traveling part of the traveling unit have limit switches, respectively, that come into contact with the striker upon arrival thereat.

The movable tube conveyor further comprises a pair of erroneous operation preventing parts including a first erroneous operation detection part and a second erroneous operation detection part configured to detect arrival of the first traveling part and the second traveling part of the traveling unit, respectively. The pair of erroneous operation preventing parts is disposed relative to the limit switches in the first traveling part and the second traveling part of the traveling unit at intervals smaller than the predetermined intervals at which the plurality of pairs of arrival detection parts are arranged, and the control unit determines that the limit switches have erroneously operated and controls the traveling of the traveling unit to stop the traveling of the traveling unit, when the pair of plurality of erroneous operation preventing parts detects arrival of the traveling unit at one of the plurality of pairs of arrival detection parts before the limit switches in the first traveling part and the second traveling part detect the arrival of the traveling unit at the one of the plurality of pairs of arrival detection parts.

The first detection parts and the second detection parts of the plurality of pairs of arrival detection parts are formed by optical switches or magnetic switches each configured to detect the arrival of the first traveling part and the second traveling part of the traveling unit.

### BRIEF DESCRIPTION OF THE DRAWINGS

FIG. 1 is a schematic top view for explaining a movable tube conveyor according to the present invention.

FIG. 2 is a schematic side view for explaining the movable tube conveyor according to the present invention.

FIG. 3 is a block diagram for explaining a control unit of the movable tube conveyor according to the present invention.

FIG. 4 is a block diagram for explaining another control unit of the movable tube conveyor according to the present invention.

FIG. 5 is a schematic side view for explaining another example of the movable tube conveyor according to the present invention.

FIG. 6 is a schematic side view for explaining still another example of the movable tube conveyor according to the present invention.

### DETAILED DESCRIPTION OF THE EMBODIMENTS

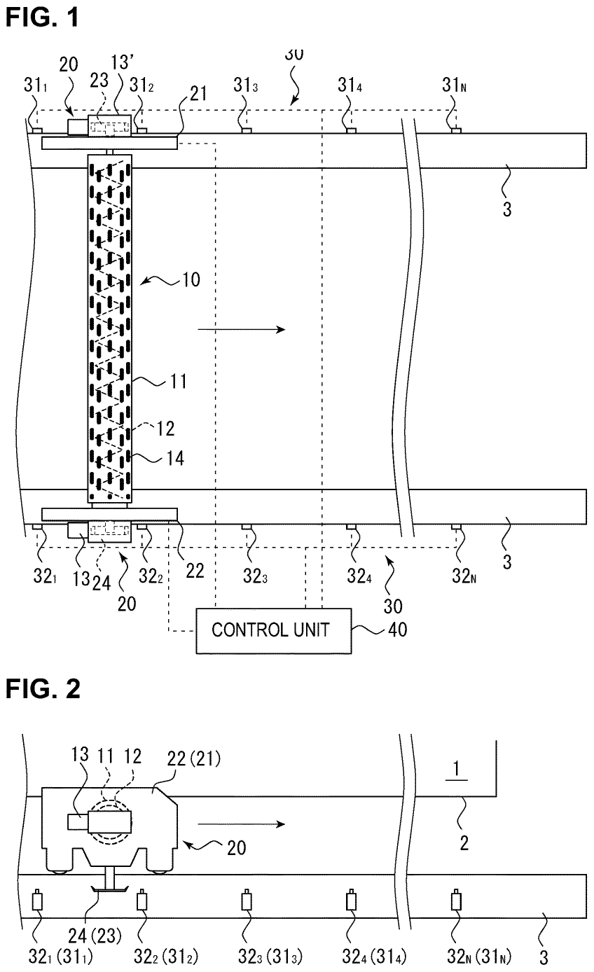

Hereinafter, an embodiment for practicing the present invention will be described with reference to the illustrated examples. FIG. 1 is a schematic top view for explaining a movable tube conveyor according to the present invention. FIG. 2 is a schematic side view for explaining the movable tube conveyor according to the present invention. In the drawing, the same reference numerals as those in FIG. 1 denote the same parts. It should be noted that each drawing is a schematic diagram, and the aspect ratio and the proportions thereof are not exact. The movable tube conveyor according to the present invention is configured to discharge bulk material from a silo 1. The bulk material may be any granular material that serves as a raw material for a finished product, such as wood chips, coal, paper pulp, peat, sand, cement, ash, grains, or pellets. The movable tube conveyor travels across a lower opening 2 of the silo 1, enabling the bulk material accumulated in the silo 1 to be uniformly discharged from the lower side of the silo 1. As illustrated in FIGS. 1 and 2, the movable tube conveyor according to the present invention mainly includes a feeder tube 10, a traveling unit 20, pairs of arrival detection parts 30, and a control unit 40.

The feeder tube 10 includes a tube 11, a screw 12, and rotating mechanisms 13 and 13′. The tube 11 has a plurality of inlet openings 14 for taking in the bulk material. The screw 12 is disposed inside the tube 11 coaxially with the tube 11. The rotating mechanisms 13 and 13′ are configured to relatively rotate the tube 11 and the screw 12 about their axes. In the illustrated examples, the rotating mechanism 13 rotates the tube 11, and the rotating mechanism 13′ rotates the screw 12. The bulk material accumulated in the silo 1 is taken into the tube 11 through the inlet openings 14 of the rotating tube 11. The bulk material is conveyed in a longitudinal direction of the tube 11 by the screw 12 rotating inside the tube 11 and is discharged from an end portion of the tube 11. In the movable tube conveyor according to the present invention, the feeder tube 10 itself may have any structure that is already known or to be developed in the future.

The traveling unit 20 includes a first traveling part 21 and a second traveling part 22. The traveling unit 20 is configured to allow the feeder tube 10 to travel across the lower opening 2 of the silo 1. The first traveling part 21 and the second traveling part 22 are provided at both ends of the tube 11. More specifically, the traveling unit 20 is configured to support both ends of a shaft of the feeder tube 10 and to cause the feeder tube 10 to travel. The traveling unit 20 may rotatably support the tube 11 and the screw 12 of the feeder tube 10 and include the rotating mechanisms 13 and 13′. The first traveling part 21 and the second traveling part 22 may each include an electric motor. The first traveling part 21 and the second traveling part 22 may be configured to be subjected to ON/OFF control by the control unit 40 to be described later. For example, ON/OFF control is performed on a power supply to the first traveling part 21 and the second traveling part 22, thereby controlling traveling of the first traveling part 21 and the second traveling part 22.

A plurality of the pairs of arrival detection parts 30 include a plurality of switches configured to detect arrival of the first traveling part 21 and the second traveling part 22, respectively. Specifically, the pairs of arrival detection parts 30 include first detection parts 31_{N} and second detection parts 32_{N}. The first detection parts 31_{N} and the second detection parts 32_{N} are arranged along a traveling direction of the traveling unit 20 so as to correspond to each other in position at intervals not exceeding a limit value of a difference in traveling distance between the first traveling part and the second traveling part. More specifically, as illustrated in FIG. 1, the first detection parts 31_{N} and the second detection parts 32_{N} are arranged along a lane 3 on which the first traveling part 21 and the second traveling part 22 of the traveling unit 20 travel. For example, a first detection part 31₁ and a second detection part 32₁ constitute a pair of arrival detection part 30₁ as a pair. The first detection part 31₁ and the second detection part 32₁ may be arranged along a line perpendicular to the lane 3. The arrangement interval between the first detection part 31₁ and the second detection part 32₁ is set to a value not exceeding a limit value of a difference in traveling distance between the first traveling part 21 and the second traveling part 22. That is, the first detection parts 31_{N} and the second detection parts 32_{N} may be arranged at such intervals that the inclination of a line connecting between the first detection part 31₁ and the second detection part 32₂ does not exceed an allowable skew range of the feeder tube 10.

The first detection part 31_{N} and the second detection part 32_{N} may each be formed by a limit switch. The limit switch is a contact switch that is turned ON by contact with an object. In order to detect arrival of the traveling unit 20 using the limit switches, the first traveling part 21 include a striker 23 and the second traveling part 22 include a striker 24, respectively. When the striker 23 and the striker 24 come into contact with the first detection part 31_{N} and the second detection part 32_{N}, respectively, the first detection part 31_{N} and the second detection part 32_{N} are turned ON, thereby detecting arrival of the first traveling part 21 and the second traveling part 22 at corresponding positions thereof.

The limit switches and the strikers may be provided in reverse. That is, the first detection part 31_{N} and the second detection part 32_{N} of the plurality of the pairs of arrival detection parts 30 may be formed by strikers, and the first traveling part 21 and the second traveling part 22 may be provided, respectively, with the limit switches that come into contact with the strikers when the first traveling part 21 and the second traveling part 22 arrive at the strikers. This configuration makes it possible to reduce the number of switches.

The first detection part 31 and the second detection part 32 used in the pairs of arrival detection parts 30 of the movable tube conveyor according to the present invention are not limited to the limit switches, and may be formed by any switches that are highly durable and operable even in a harsh environment. Further, the first detection part 31 and the second detection part 32 need not be formed by the contact switches, and may be optical switches or magnetic switches, provided that the switches are capable of detecting arrival of the first traveling part 21 and the second traveling part 22 of the traveling unit 20.

The control unit 40 is configured to control traveling of the traveling unit 20. The control unit 40 is an electronic controller that includes one or a plurality of processors. For example, the control unit 40 is configured to include one or more of CPUs (Central Processing Unit). Here, the term “electronic controller” as used herein refers to hardware, and does not include a human. The control unit 40 can be configured to include, instead of the CPU or in addition to the CPU, one or more types of processors, such as a DSP (Digital Signal Processor), an FPGA (Field Programmable Gate Array), an ASIC (Application Specific Integrated Circuit), and the like. Specifically, when one of the first detection parts 31_{N} detects arrival of the first traveling part 21, the control unit 40 stops traveling of the first traveling part 21 until one of the second detection parts 32_{N} corresponding to the one of the first detection parts 31_{N} detects arrival of the second traveling part 22. For example, when the first detection part 31₁ detects arrival of the first traveling part 21, the control unit 40 stops traveling of the first traveling part 21 until the second detection part 321 corresponding to the first detection part 31₁ detects arrival of the second traveling part 22. As a result, the first traveling part 21 and the second traveling part 22 can be caused to travel in step with each other at each arrangement interval of the plurality of the pairs of arrival detection parts 30. Such control by the control unit 40 allows the traveling unit 20 to travel while a difference in traveling distance between the first traveling part 21 and the second traveling part 22 does not exceed a limit value. The control unit 40 may be configured to receive signals from the switches of the plurality of the pairs of arrival detection parts 30. Further, the control unit 40 may be configured to transmit control signals for traveling control to the traveling unit 20.

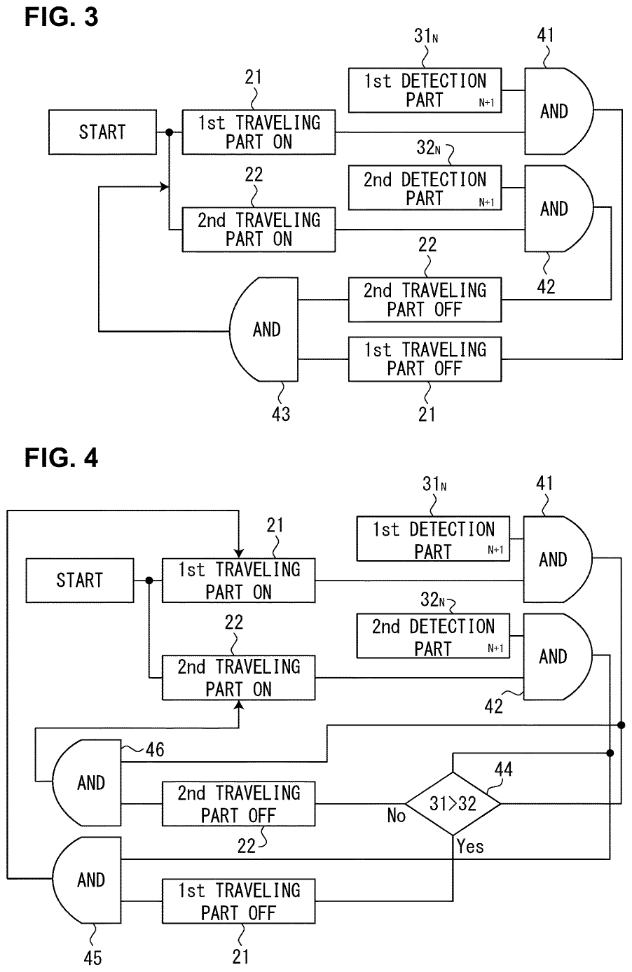

The control by the control unit 40 will be described in more detail with reference to FIG. 3. FIG. 3 is a block diagram for explaining the control unit of the movable tube conveyor according to the present invention. In the drawing, the same reference numerals as those in FIGS. 1 and 2 denote the same parts. Steps commonly required to start up traveling unit, such as start-up conditions, are omitted. The illustrated control unit 40 controls traveling of the traveling unit 20 such that, when a certain first detection part 31_{N} detects arrival of the first traveling part 21, traveling of the first traveling part 21 is stopped until a certain second detection part 32_{N} corresponding to the certain first detection part 31_{N} detects arrival of the second traveling part 22. Then, when the certain second detection parts 32_{N} detects arrival of the second traveling part 22, traveling of the second traveling part 22 is stopped, and thereafter traveling of the second traveling part 22 is resumed together with the first traveling part 21 which has already been stopped. That is, in the illustrated control, the first traveling part 21 and the second traveling part 22 are turned OFF each time they arrive at the pairs of arrival detection parts 30, and are thereafter turned ON and restarted in step with each other.

Specifically, the control unit 40 transmits a start command to the traveling unit 20. In response to the start command, traveling of the first traveling part 21 and the second traveling part 22 is turned ON and starts traveling. Then, when one of the first detection parts 31_{N} is turned ON while the first traveling part 21 is in an ON state, the first traveling part 21 is turned OFF by an AND block 41. Similarly, when one of the second detection parts 32_{N} is turned ON while the second traveling part 22 is in an ON state, the second traveling part 22 is turned OFF by an AND block 42. Then, when both the first traveling part 21 and the second traveling part 22 are turned OFF, the first traveling part 21 and the second traveling part 22 are turned ON once again by an AND block 43 and start traveling. Then, the N of the first detection part 31_{N} and the second detection part 32_{N} increments to N+1, and turning ON of the subsequent of the pairs of arrival detection parts 30 is detected. The above control is repeatedly performed until turning ON of the last of the pairs of arrival detection parts 30 is detected. When turning ON of the last of the pairs of arrival detection parts 30 is detected, the traveling unit 20 may be caused to travel backward. In this case, the N of the first detection part 31_{N} and the second detection part 32_{N} decrements to N-1, and turning ON of the subsequent of the pairs of arrival detection parts 30 in a backward traveling direction is detected.

FIG. 4 is a block diagram for explaining another control unit of the movable tube conveyor according to the present invention. In the drawing, the same reference numerals as those in FIGS. 1 and 2 denote the same parts. Steps commonly required to start up traveling unit, such as start-up conditions, are omitted. The illustrated control unit 40 controls traveling of the traveling unit 20 such that, when one of the second detection parts 32_{N} detects arrival of the second traveling part 22, traveling of the second traveling part 22 is continued, and traveling of the first traveling part 21, which has already been stopped, is resumed. That is, in the illustrated control, one of the first traveling part 21 and the second traveling part 22 that arrives earlier at the pairs of arrival detection parts 30 is temporarily turned OFF, and thereafter turned ON in accordance with timing at which the other traveling part arrives at the pairs of arrival detection parts 30, whereby the first traveling part 21 and the second traveling parts 22 are caused to start traveling in step with each other.

Specifically, first, the control unit 40 transmits a start command to the traveling unit 20. In response to the start command, traveling of the first traveling part 21 and the second traveling part 22 is turned ON and starts traveling. Then, when one of the first detection parts 31_{N} is turned ON while the first traveling part 21 is in an ON state, the first traveling part 21 is turned OFF by the AND block 41. Similarly, when one of the second detection parts 32_{N} is turned ON while the second traveling part 22 is in an ON state, the second traveling part 22 is turned OFF by the AND block 42. Then, before turning OFF the first traveling part 21 or the second traveling part 22, a comparison block 44 compares timing at which one of the first detection parts 31_{N} is turned ON with timing at which one of the second detection parts 32_{N} disposed at a position corresponding to the one first detection part 31_{N} is turned ON. For example, when the one of the first detection parts 31_{N} is turned ON earlier, traveling of the first traveling part 21 is stopped. Thereafter, an AND block 45 continues traveling of the second traveling part 22 while maintaining the ON state thereof even when one of the second detection parts 32_{N} is turned ON, and resumes traveling of the first traveling part 21 that has already been stopped. Similarly, when it is determined that one of the second detection parts 32_{N} is turned ON earlier, the comparison block 44 stops traveling of the second traveling part 22. Thereafter, an AND block 46 continues traveling of the first traveling part 21 while maintaining the ON state thereof even when one of the first detection parts 31_{N} is turned ON, and resumes traveling of the second traveling part 22 that has already been stopped. Such control may be repeated until the last of the pairs of arrival detection parts 30.

As described above, in the movable tube conveyor according to the present invention, arrival of the traveling unit 20 at the arrangement positions of the pairs of arrival detection parts 30 can be physically detected by the pairs of arrival detection parts 30, thereby reducing a risk of erroneous operation. Therefore, it is possible to prevent skewing of the feeder tube 10 reliably. Further, the switches are simple mechanical components and are therefore resistant to heat and vibration. Furthermore, no particular control is required for the traveling unit 20 until the traveling unit 20 arrives at a subsequent of the pairs of arrival detection parts 30, thereby eliminating the need to continuously perform high-level control for the first traveling part 21 and the second traveling part 22. This enables manufacture at low cost.

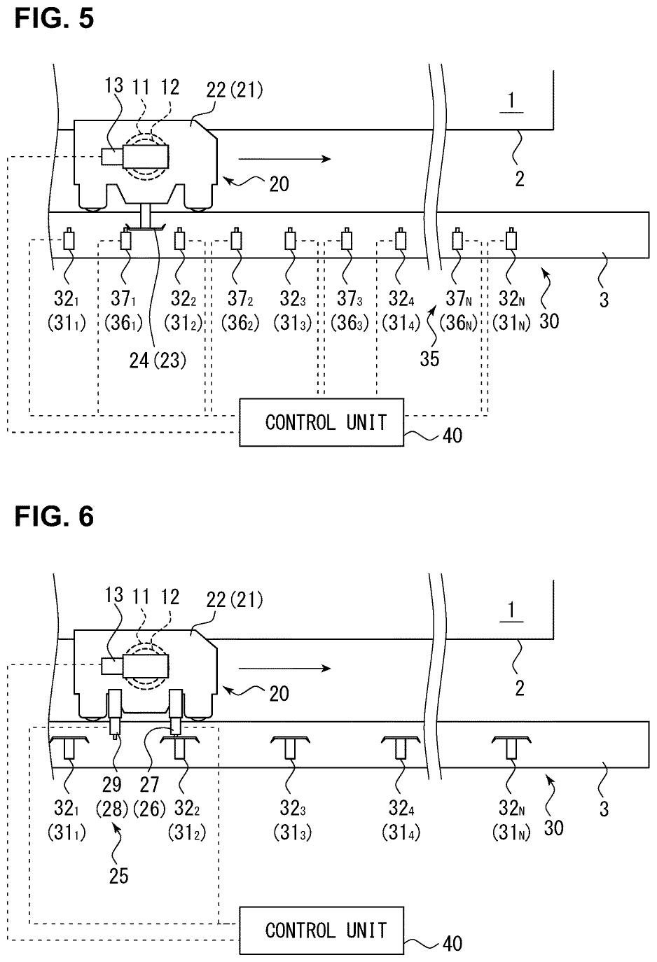

Next, another example of the movable tube conveyor according to the present invention will be described with reference to FIG. 5. FIG. 5 is a schematic side view for explaining another example of the movable tube conveyor according to the present invention. In the drawing, the same reference numerals as those in FIG. 1 denote the same parts. The movable tube conveyor illustrated in FIG. 5 is configured to prevent erroneous operation. As illustrated, the movable tube conveyor according to the present invention further includes a plurality of pairs of erroneous operation preventing parts 35 in addition to the configuration illustrated in FIGS. 1 and 2. The pairs of erroneous operation preventing parts 35 include first erroneous operation detection parts 36_{N} and second erroneous operation detection parts 37_{N}. The pairs of erroneous operation preventing parts 35 are configured to detect arrival of the first traveling part 21 and the second traveling part 22, respectively. Specifically, the first erroneous operation detection parts 36_{N} is configured to arrival of the first traveling part 21, and the second erroneous operation detection parts 37_{N} is configured to detect arrival of the second traveling part 22. As illustrated in FIG. 5, the pairs of erroneous operation preventing parts 35 thus configured are disposed at positions between predetermined intervals where the plurality of the pairs of arrival detection parts 30 are arranged. Specifically, for example, the second erroneous operation detection part 37₁ is disposed between the second detection part 32₁ and the second detection part 32₂.

The control unit 40 controls traveling of the traveling unit to stop traveling of the traveling unit 20 by determining that a certain pair of arrival detection parts 30 has erroneously operated when a next pair of erroneous operation preventing parts 35 adjacent in the traveling direction detects arrival of the traveling unit 20 before the certain pair of arrival detection parts 30 detects arrival of the traveling unit 20. Specifically, when, before the second detection part 32₂ detects arrival of the second traveling part 22, the second erroneous operation detection part 37₂ next thereto detects arrival of the second traveling part 22, the control unit 40 determines that the second detection part 32₂ has erroneously operated. For example, although the control unit 40 would normally receive an arrival detection signal from the second detection part 32₂, the control unit 40 does not receive the arrival detection signal in a fault state. As a result, the control unit 40 receives an arrival detection signal from the second erroneous operation detection part 37₂, while no arrival detection signal is received from the second detection part 32₂. This allows the control unit 40 to detect occurrence of an erroneous operation in the second detection part 32₂. Using the thus configured pairs of erroneous operation preventing parts 35, the movable tube conveyor according to the present invention can more reliably prevent erroneous operation.

Each of switches of the pairs of erroneous operation preventing parts 35 may be a switch similar to that of the pairs of arrival detection parts 30, such as a limit switch. However, the present invention is not limited to this, and the pairs of erroneous operation preventing parts 35 may be formed by switches employing a detection method different from that of the first detection parts 31_{N} and the second detection parts 32_{N}. By using switches employing different detection methods, durability and performance can be differentiated even in the same environment, thereby allowing the different switches to mutually function to prevent erroneous operation.

Further, the plurality of the pairs of erroneous operation preventing parts 35 may be provided by using the plurality of the pairs of arrival detection parts 30. The plurality of the pairs of arrival detection parts 30 may be arranged at sufficiently small intervals such that, even when one traveling part passes one switch and reaches a next switch, the feeder tube 10 does not exceed an allowable skew range. That is, it is sufficient that a distance between a given switch and a next-but-one switch does not exceed an allowable skew range.

Still another example of the movable tube conveyor according to the present invention will be described with reference to FIG. 6. FIG. 6 is a schematic side view for explaining still another example of the movable tube conveyor according to the present invention. In the drawing, the same reference numerals as those in FIG. 1 denote the same parts. The movable tube conveyor illustrated in FIG. 6 is configured to prevent erroneous operation. As illustrated, the first detection part 31 and the second detection part 32 of the plurality of the pairs of arrival detection parts 30 are each formed by strikers. The first traveling part 21 has a first limit switch 26 that comes into contact with one of the first detection parts 31_{N} upon arrival thereat. The second traveling part 22 has a second limit switch 27 that comes into contact with one of the second detection parts 32_{N} upon arrival thereat.

Even in the thus configured movable tube conveyor according to the present invention, the control unit 40 can control traveling of the traveling unit 20 in the same manner as in the above-described examples. Specifically, when arrival of the first traveling part 21 at a certain first detection parts 31_{N} is detected by the first limit switch 26, traveling of the first traveling part 21 is stopped until arrival of the second traveling part 22 at a certain second detection parts 32_{N} disposed at a position corresponding to the certain first detection parts 31_{N} is detected by the second limit switch 27. As a result, the first traveling part 21 and the second traveling part 22 can be caused to travel in step with each other at each arrangement interval of the plurality of the pairs of arrival detection parts 30.

The movable tube conveyor according to the present invention illustrated in FIG. 6 may further include a pair of erroneous operation preventing parts 25. The pair of erroneous operation preventing parts 25 includes a first erroneous operation detection part 28 provided on the first traveling part 21 and a second erroneous operation detection part 29 provided on the second traveling part 22. The pair of erroneous operation preventing parts 25 is configured to detect arrival of the first traveling part 21 and the second traveling part 22 at the pairs of arrival detection parts 30, respectively. Specifically, the first erroneous operation detection part 28 and the second erroneous operation detection part 29 may each be formed by a limit switch. The first erroneous operation detection part 28 is disposed relative to the first limit switch 26 at intervals smaller than predetermined intervals at which the plurality of the pairs of arrival detection parts 30 are arranged. Similarly, the second erroneous operation detection part 29 is disposed relative to the second limit switch 27 at intervals smaller than predetermined intervals at which the plurality of the pairs of arrival detection parts 30 are arranged.

The control unit 40 determines that the first limit switch 26 or the second limit switch 27 has erroneously operated when the pair of erroneous operation preventing parts 25 detect arrival of the traveling unit 20 at the pairs of arrival detection parts 30 before the first limit switch 26 and the second limit switch 27, each of which the first traveling part 21 and the second traveling part 22 have, detect arrival of the traveling unit 20 at the pair of erroneous operation preventing parts 25. Then, the control unit 40 may control traveling of the traveling unit 20 to stop traveling of the traveling unit 20. Specifically, when the second erroneous operation detection part 29 detects arrival of the second traveling part 22 at the second detection part 32₂ before the second limit switch 27 detects arrival of the second traveling part 22 at the second detection part 32₂, the control unit 40 determines that the second limit switch 27 has erroneously operated. For example, although the control unit 40 would normally receive an arrival detection signal from the second limit switch 27, the control unit 40 does not receive the arrival detection signal in a fault state. As a result, the control unit 40 receives an arrival detection signal from the second erroneous operation detection part 29, while no arrival detection signal is received from the second limit switch 27. This allows the control unit 40 to detect occurrence of an erroneous operation in the second limit switch 27. With this configuration, the control unit 40 needs to be connected only to the traveling unit 20, thereby simplifying the configuration.

The embodiments described above are specific examples of the following aspects.

(Aspect 1) A movable tube conveyor for discharging bulk material from a silo, the movable tube conveyor comprising:
a feeder tube including a tube having a plurality of inlet openings for taking in the bulk material, a screw disposed inside the tube and sharing a common axis with the tube, and rotating mechanisms each configured to relatively rotate the tube and the screw about the common axis;
a traveling unit configured to allow the feeder tube to travel across a lower opening of the silo and including a first traveling part and a second traveling part disposed at both ends of the tube;
a plurality of pairs of arrival detection parts configured to detect arrival of the first traveling part and the second traveling part, respectively, of the traveling unit and including first detection parts and second detection parts arranged along a traveling direction of the traveling unit so as to correspond to each other in position at predetermined intervals not exceeding a limit value of a difference in traveling distance between the first traveling part and the second traveling part; and
a control unit configured to control traveling of the traveling such that the difference in the traveling distance between the first traveling part and the second traveling part does not exceed the limit value, by stopping, when one of the first detection parts of the plurality of pairs of the arrival detection parts detects arrival of the first traveling part, traveling of the first traveling part until one of the second detection parts which is disposed corresponding to the one of the first detection parts, detects arrival of the second traveling part.

(Aspect 2) The movable tube conveyor according to aspect 1, wherein the control unit controls the traveling of the traveling unit such that, when the one of the second detection parts detects the arrival of the second traveling part, traveling of the second traveling part is stopped, and thereafter the traveling of the second traveling part is resumed together with the first traveling part which has already been stopped.

(Aspect 3) The movable tube conveyor according to aspect 1, wherein the control unit controls the traveling of the traveling unit such that, when the one of the second detection part detects the arrival of the second traveling part, traveling of the second traveling part is continued, and the traveling of the first traveling part, which has already been stopped, is resumed.

(Aspect 4) The movable tube conveyor according to aspect 1, wherein
the first arrival detection parts and the second arrival detection parts of the plurality of pairs of arrival detection parts are each formed by a limit switch, and
the first traveling part and the second traveling part of the traveling unit each have a striker that comes into contact with the limit switch upon arrival thereat.

(Aspect 5) The movable tube conveyor according to aspect 4, further comprising a plurality of pairs of erroneous operation preventing parts including first erroneous operation detection parts and second erroneous operation detection parts each configured to detect arrival of the first traveling part and the second traveling part of the traveling unit, wherein
the plurality of pairs of erroneous operation preventing parts are disposed at positions between the predetermined intervals at which the plurality of pairs of arrival detection parts are arranged, and
the control unit determines that one of the plurality of pairs of arrival detection parts has erroneously operated and controls the traveling of the traveling unit to stop the traveling of the traveling unit when a next pair of the plurality of pairs of erroneous operation preventing parts, which is adjacent to the one of the plurality of pairs of arrival detection parts in the traveling direction detects arrival of the traveling unit before the one of the plurality of pairs of arrival detection parts detects arrival of the traveling unit.

(Aspect 6) The movable tube conveyor according to aspect 5, wherein the plurality of pairs of erroneous operation preventing parts are formed by using the plurality of pairs of arrival detection parts. (Aspect 7) The movable tube conveyor according to aspect 1, wherein
the first detection parts and the second detection parts of the plurality of pairs of arrival detection parts are each formed by a striker, and
the first traveling part and the second traveling part of the traveling unit have limit switches, respectively, that come into contact with the striker upon arrival thereat.

(Aspect 8) The movable tube conveyor according to aspect 7, further comprising a pair of erroneous operation preventing parts including a first erroneous operation detection part and a second erroneous operation detection part configured to detect arrival of the first traveling part and the second traveling part of the traveling unit, respectively, wherein
the pair of erroneous operation preventing parts is disposed relative to the limit switches in the first traveling part and the second traveling part of the traveling unit at intervals smaller than the predetermined intervals at which the plurality of pairs of arrival detection parts are arranged, and
the control unit determines that the limit switches have erroneously operated and controls the traveling of the traveling unit to stop the traveling of the traveling unit when the pair of erroneous operation preventing parts detects arrival of the traveling unit at one of the plurality of pairs of arrival detection parts before the limit switches in the first traveling part and the second traveling part detect the arrival of the traveling unit at the one of the plurality of pairs of arrival detection parts.

(Aspect 9) The movable tube conveyor according to aspect 1, wherein the first detection parts and the second detection parts of the plurality of pairs of arrival detection parts are formed by optical switches or magnetic switches of each configured to detect the arrival of the first traveling part and the second traveling part of the traveling unit.

The movable tube conveyor according to the present invention is not limited to the above-described examples, and various modifications may be made within the scope of the present invention.

### Advantageous Effects

The movable tube conveyor according to the present invention is advantageous in that it is resistant to damage, has a reduced risk of erroneous detection, and can be manufactured at low cost.

What is claimed is:

1. A movable tube conveyor for discharging bulk material from a silo, the movable tube conveyor comprising:
a feeder tube including a tube having a plurality of inlet openings for taking in the bulk material, a screw disposed inside the tube and sharing a common axis with the tube, and rotating mechanisms each configured to relatively rotate the tube and the screw about the common axis;
a traveling unit configured to allow the feeder tube to travel across a lower opening of the silo and including a first traveling part and a second traveling part disposed at both ends of the tube;
a plurality of pairs of arrival detection parts configured to detect arrival of the first traveling part and the second traveling part, respectively, of the traveling unit and including first detection parts and second detection parts arranged along a traveling direction of the traveling unit so as to correspond to each other in position at predetermined intervals not exceeding a limit value of a difference in traveling distance between the first traveling part and the second traveling part; and
a control unit configured to control traveling of the traveling unit such that the difference in the traveling distance between the first traveling part and the second traveling part does not exceed the limit value, by stopping, when one of the first detection parts of the plurality of pairs of the arrival detection parts detects arrival of the first traveling part, traveling of the first traveling part until one of the second detection parts, which is disposed corresponding to the one of the first detection parts, detects arrival of the second traveling part.

2. The movable tube conveyor according to claim 1, wherein
the control unit controls the traveling of the traveling unit such that, when the one of the second detection parts detects the arrival of the second traveling part, traveling of the second traveling part is stopped, and thereafter the traveling of the second traveling part is resumed together with the first traveling part which has already been stopped.

3. The movable tube conveyor according to claim 1, wherein
the control unit controls the traveling of the traveling unit such that, when the one of the second detection parts detects the arrival of the second traveling part, traveling of the second traveling part is continued, and the traveling of the first traveling part, which has already been stopped, is resumed.

4. The movable tube conveyor according to claim 1, wherein
the first arrival detection parts and the second arrival detection parts of the plurality of pairs of arrival detection parts are each formed by a limit switch, and
the first traveling part and the second traveling part of the traveling unit each have a striker that comes into contact with the limit switch upon arrival thereat.

5. The movable tube conveyor according to claim 4, further comprising a plurality of pairs of erroneous operation preventing parts including first erroneous operation detection parts and second erroneous operation detection parts each configured to detect arrival of the first traveling part and the second traveling part of the traveling unit, wherein
the plurality of pairs of erroneous operation preventing parts are disposed at positions between the predetermined intervals at which the plurality of pairs of arrival detection parts are arranged, and
the control unit determines that one of the plurality of pairs of arrival detection parts has erroneously operated and controls the traveling of the traveling unit to stop the traveling of the traveling unit, when a next pair of the plurality of pairs of erroneous operation preventing parts, which is adjacent to the one of the plurality of pairs of arrival detection parts in the traveling direction, detects arrival of the traveling unit before the one of the plurality of pairs of arrival detection parts detects arrival of the traveling unit.

6. The movable tube conveyor according to claim 5, wherein
the plurality of pairs of erroneous operation preventing parts are formed by using the plurality of pairs of arrival detection parts.

7. The movable tube conveyor according to claim 1, wherein
the first detection parts and the second detection parts of the plurality of pairs of arrival detection parts are each formed by a striker, and
the first traveling part and the second traveling part of the traveling unit have limit switches, respectively, that come into contact with the striker upon arrival thereat.

8. The movable tube conveyor according to claim 7, further comprising a pair of erroneous operation preventing parts including a first erroneous operation detection part and a second erroneous operation detection part configured to detect arrival of the first traveling part and the second traveling part of the traveling unit, respectively, wherein
the pair of erroneous operation preventing parts is disposed relative to the limit switches in the first traveling part and the second traveling part of the traveling unit at intervals smaller than the predetermined intervals at which the plurality of pairs of arrival detection parts are arranged, and
the control unit determines that the limit switches have erroneously operated and controls the traveling of the traveling unit to stop the traveling of the traveling unit, when the pair of erroneous operation preventing parts detects arrival of the traveling unit at one of the plurality of pairs of arrival detection parts before the limit switches in the first traveling part and the second traveling part detect the arrival of the traveling unit at the one of the plurality of pairs of arrival detection parts.

9. The movable tube conveyor according to claim 1, wherein
the first detection parts and the second detection parts of the plurality of pairs of arrival detection parts are formed by optical switches or magnetic switches each configured to detect the arrival of the first traveling part and the second traveling part of the traveling unit.
